(19) United States
(12) Patent Application Publication
(10) Pub. No.: US 2017/0291808 A1
(43) Pub. Date: Oct. 12, 2017

(54) Wine Dispensing Systems and Methods

(71) Applicants: Steve Young, St. Louis, MO (US); Jeffrey Macler, Tecumseh, MO (US); William Jaouad Ziadi, Fenton, MO (US)

(72) Inventors: Steve Young, St. Louis, MO (US); Jeffrey Macler, Tecumseh, MO (US); William Jaouad Ziadi, Fenton, MO (US)

(21) Appl. No.: 15/481,918

(22) Filed: Apr. 7, 2017

Related U.S. Application Data
(60) Provisional application No. 62/319,778, filed on Apr. 7, 2016.
(60) Provisional application No. 62/369,539, filed on Aug. 1, 2016.

(51) Int. Cl. B67D 1/08; B67D 1/00

(52) U.S. Cl. CPC B67D 1/0888; B67D 1/0872; B67D 1/0004; B67D 1/0804; B67D 1/0869

(57) ABSTRACT

Systems and methods for dispensing chilled wine using a dispensing appliance. The appliance generally comprises a housing or enclosure protecting internal components and providing a chilled chamber for wine storage and an unchilled chamber for electric and other components. An airtight wine “silo” containing a packaged wine is insertable into a cradle in the chilled chamber for attaching to a fluid connector system. The user operates a handle to control wine flow. Identifiers on the silo may be read and transmitted to a server, where learning algorithms can suggest alternative wines the user may like based on user feedback about prior wines used with the appliance.

### CROSS-REFERENCE TO RELATED APPLICATIONS

This application claims benefit of U.S. Provisional Patent Application No. 62/319,778, filed Apr. 7, 2016, and U.S. Provisional Patent Application No. 62/369,539, filed Aug. 18, 2016. The entire disclosure of both these documents is expressly incorporated herein by reference.

### BACKGROUND OF THE INVENTION

### Field of the Invention

This disclosure relates to systems for storing, transporting, and dispensing wine.

### Description of the Related Art

There has been little innovation in the field wine storage and dispensing, with the millennia-old glass bottle and cork remaining the primary means by which wine is stored and dispensed for consumption. This practice is so pervasive that wine distributed in any other way is sometimes regarded as cheap or of lower quality. This has in turn given rise to an industry of accessory products to improve the taste experience when consuming bottled wine, ranging from chillers to aerators.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Described herein, among other things, is a wine dispensing system comprising: a fluid silo comprising an internal bladder inside an outer housing, the internal bladder having a fluid connector fitment at an end thereof; a housing having a chilled chamber and an unchilled chamber; a cradle disposed in the chilled chamber, the cradle configured to hold the fluid silo; a fluid connecting system disposed in the chilled chamber and configured to connect fitment of the fluid silo when disposed in the cradle; a dispensing nozzle external to the housing and in fluid communication with the fluid connecting system; and a cooling system configured to cool the chilled chamber.

In an embodiment, the wine dispensing system further comprises: the fluid silo comprising an identifier of the fluid content of the fluid silo; a scanning means configured to detect the identifier when the fluid silo is in the cradle; and a transmitter configured to transmit the detected identifier.

In another embodiment, the identifier comprises a radio frequency identification (RFID) tag.

In another embodiment, the scanning means comprises an RFID tag reader.

In another embodiment, the transmitter is a short-range radio frequency transmitter.

In another embodiment, the system further comprises a display configured to receive signals indicative of the identifier and to display a visual representation of the identifier.

In another embodiment, the visual representation is selected from the group consisting of: a word; a phrase; a logo; a brand name; bottle label; and, a type of wine.

In another embodiment, the system further comprises: a computer configured to receive the transmitted detected identifier.

In another embodiment, the computer comprises a mobile device.

In another embodiment, the mobile device comprises a smart phone, tablet computer, or wearable computer.

In another embodiment, the computer comprises a non-transitory computer-readable medium having program instructions thereon for causing the computer to receive the detected identifier transmitted by the transmitter.

In another embodiment, the system further comprises a remote computer server comprising a non-transitory computer-readable medium having program instructions thereon for causing the remove server to receive the detected identifier transmitted by the transmitter.

In another embodiment, the non-transitory computer-readable medium further comprises program instructions for: receiving user input indicative of user ratings of a wine; selecting other wines the user may like based upon the received user ratings; and transmitting identifiers for the selected other wines.

In another embodiment, the fitment connects to the fluid connecting system by rotating the fitment.

In another embodiment, the system further comprises a pump operatively connected to a manipulable control which, when manipulated, causes the pump to operate to draw fluid from the fluid silo connected to the fluid connecting system.

In another embodiment, the fluid drawn from the fluid silo flows to and is dispensed from the dispensing nozzle via a fluid conduit.

In another embodiment, the system further comprises a wine aerator disposed between the fluid connecting system and the dispensing nozzle in the fluid conduit.

In another embodiment, the system further rcomprises a heat sink disposed between the chilled chamber and the unchilled chamber, the heat sink configured to remove heat from the chilled chamber and radiate the removed heat into the unchilled chamber.

In another embodiment, the unchilled chamber further comprises one or more vents, and one or more fans in the unchilled chamber.

### BRIEF DESCRIPTION OF THE DRAWINGS

FIG. 1 depicts an external view of four embodiments of a wine dispenser according to the present disclosure.

FIG. 2 depict an embodiment of a wine dispenser according to the present disclosure with the outer covering removed.

FIG. 3 depicts a cutaway view of the interior components of a wine dispenser according to the present disclosure.

FIG. 4 depicts a cutaway view of the interior components of a wine dispenser according to the present disclosure.

FIG. 5 depicts a cutaway view of a silo canister according to the present disclosure.

FIG. 6 depicts a side elevation cutaway view of an assembled wine dispenser according to the present disclosure.

FIG. 7 depicts a method of cooling wine in a wine dispenser according to the present disclosure.

FIG. 8 depicts a label holder for use with a wine dispenser according to the present disclosure.

FIG. 9 depicts a variable flow rate pour control handle in cooperation with a potentiometer.

FIG. 10 depicts a cutaway diagram of an aerator according to the present disclosure.

FIGS. 11A and 11B depict schematic diagrams of an embodiment of an attaching system according to the present invention.

FIG. 12 depicts an exploded diagram of an embodiment of a canister according to the present embodiment.

FIG. 13 depicts an embodiment of system for providing wine recommendations to a user according to the present disclosure.

### DESCRIPTION OF THE PREFERRED EMBODIMENTS

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, is a wine dispenser that both chills and optionally aerates wine. Also described herein, among other things, are methods for cooling wine stored in a wine dispenser.

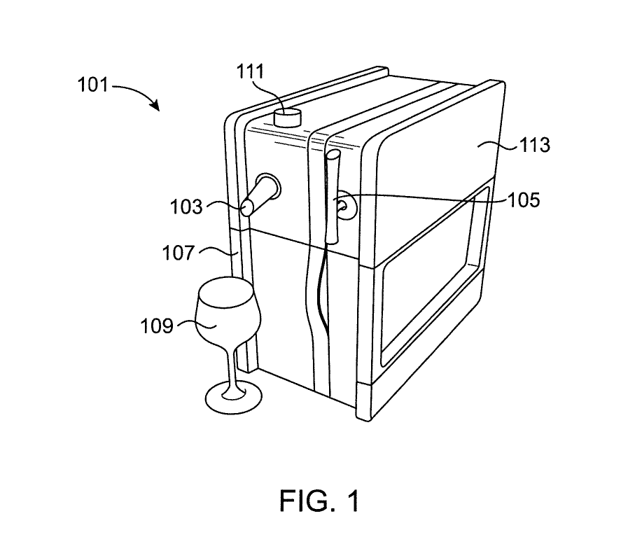

FIG. 1. depicts four embodiments according to the present disclosure. In the depicted embodiment, an external view of assembled dispensers is shown. The dispenser (101) generally comprises an enclosure or covering (113) that entirely, or almost entirely, encloses the internal components, which are described later. The exterior generally comprises decorative covering or panels snugly fitted to give an attractive appearance, as the dispenser (101) is intended for countertop use. In an embodiment, the exterior may further comprise decorative illumination, such as a glow strip. The depicted dispenser includes a spigot or spout (103), from which wine pours when the device (101) is operated. An operational control (105), a handle in the depicted embodiment, turns the flow of wine on and off. In an embodiment, the handle (105) is operated by twisting the handle (105) clockwise or counter-clockwise.

In a further embodiment, the flow rate of wine is variable, depending upon the amount by which the handle (105) is rotated. By way of example and not limitation, a turn of about 60° from the vertical or neutral position corresponds to maximum flow rate. In such an embodiment, a spring mechanism may be connected to the handle (105) so as to return it (105) to the vertical or neutral position when released. Such a spring may be any spring mechanism known in the art, including, but not necessarily limited to, a torsion spring.

The device (101) further comprises a door (107) which in normal operating conditions is closed and configured to lock in place and remain closed. The door (107), when opened, provides access to the internal components for replacing the wine canister (501) described elsewhere herein. To use the device, a receptacle (109) such as a wine glass (109) is placed under the spigot (103) and the control handle (105) is operated to cause the internal components to pour the wine from the spigot (103), optionally by going through an aerator (225). The aerator (225) is enabled in the depicted embodiment using a second control (111), such as, but not limited to, a button or switch.

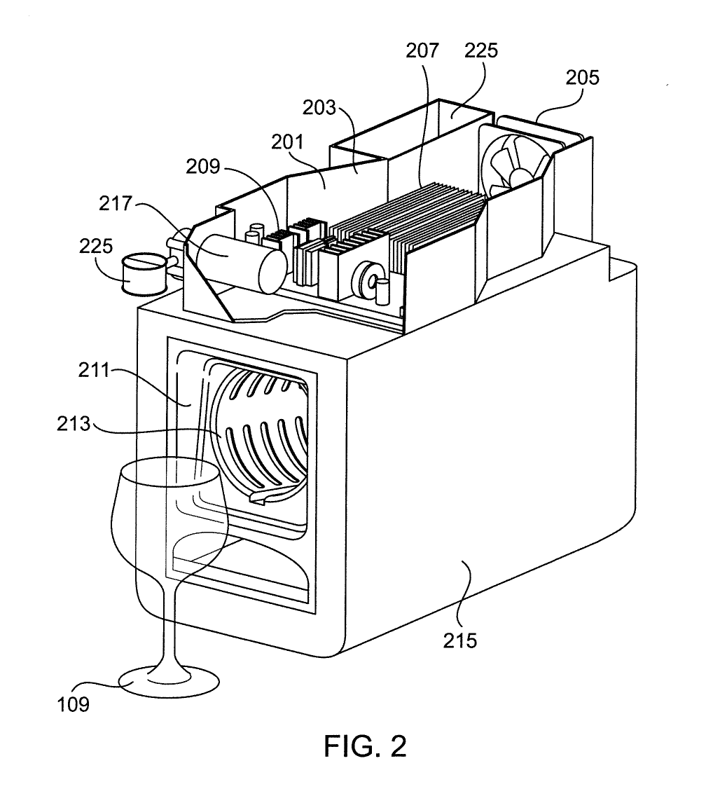

FIG. 2 depicts an embodiment of a dispenser (101) with the outer covering removed. The depicted dispenser (101) generally comprises two main portions: top “duct” portion (201) and a bottom “cooling” portion (211). The duct (201) is generally enclosed by ducting walls (203), which are sized, shaped, configured, and disposed to facilitate airflow through the duct (201). A purpose of the duct (201) is to house the heat generating components of the device (101) and keep them separate from the wine, which is stored in the cooling area (211) of the device. Cooling is generally accomplished by a fan (205) disposed at one end of the duct (201), which draws the hot air out of the duct (201) and into the ambient atmosphere outside the device (101). The depicted duct (201) is wider at the end opposing the fan (205), and narrower at the fan (205), further facilitating airflow through the duct (201).

Also disposed in the duct (201) is a heat sink (207). The heat sink (207) is generally sized, shaped, and configured to dissipate heat via air cooling, such as by drawing air across the fins of the heat sink (207) via the fan (205). As described elsewhere herein, the heat sink (207) is generally disposed adjacent to the cooling system in the cooling area (211) so that heat drawn from the cooling area (211) can be radiated from the heat sink (207) and expelled from the device (101) by the fan (205) drawing air across the heat sink (207).

Also disposed in the duct (201) are electronic components (209) for operating the system, such as circuit boards and microcontrollers. These elements also generate heat and thus are preferably disposed in the duct (201), away from the cooling area (211), where the heat they generate can be expelled from the device (101) using the fan (205), similar to the heat sink (207).

Also disposed in or near the duct (201) is a pump (217). The pump (217) is in fluid communication with a wine canister (501) as described elsewhere herein and is operationally connected to the control (105). When the control (105) is operated, the pump (217) is activated, pumping wine from the canister (501) to the spigot (103), from which it can be dispensed. This operation is facilitated by a microcontroller or other appropriate circuitry in the electronic components (209). If the second control (111) is also operated, the wine also may be pumped through the aerator (225) before being dispensed by the spigot (103). This is facilitated by the electronic components (209).

Also depicted in FIG. 2 is a cradle (213). The cradle (213) is sized and shaped for snugly holding in place a wine canister (501) as described elsewhere herein. Because the canister (501) is generally tubular, the cradle (213) is also generally tubular. The depicted cradle (213) is disposed at an angle, which helps the flow of wine and to drain the canister (501) of wine when it is nearly empty.

The bulk of the interior of the device (101) is a cooling area (211). The cradle (213) is disposed in the cooling area (211) so that when a wine canister (501) is placed in the cradle (213), it will cool as described elsewhere herein. The cooling area (211) is generally enclosed by insulation (215), which further helps to maintain a cool temperature in the cooling area.

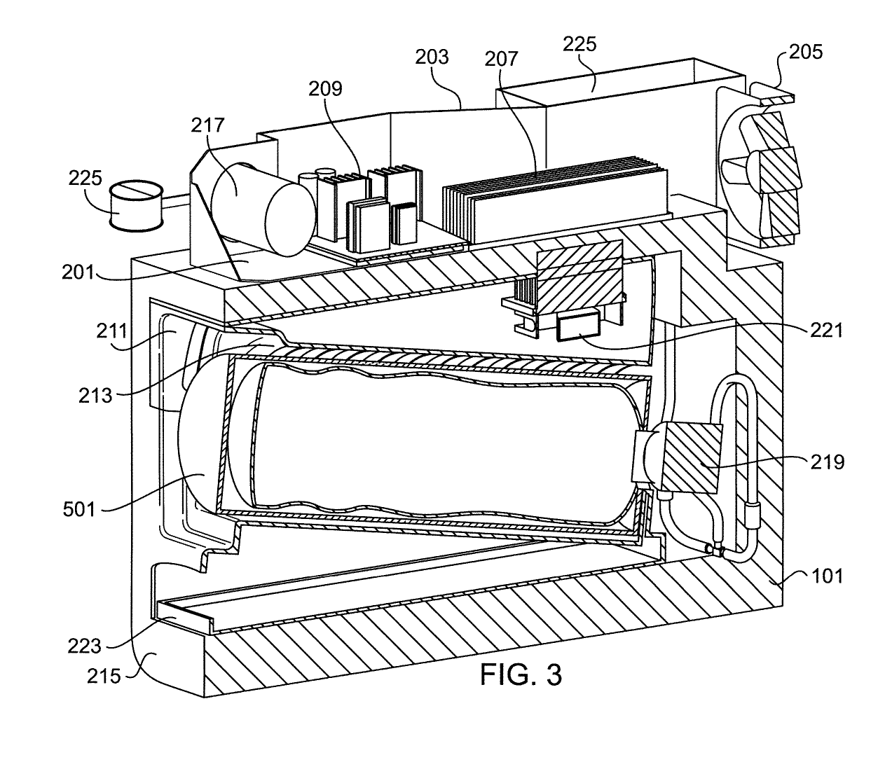

FIG. 3 depicts a side cutway of the interior components of the device (101). In addition to elements already described, FIG. 3 depicts a wine canister (501) disposed in the cradle (213), and a pan or tray (223) disposed beneath the canister (501). The pan is generally waterproof, allowing any moisture that condenses within the cooling area (211) to drip safely unto the pan (223), which can be removed and drained. In an embodiment, the pan (223) may be in fluid communication with a hose or tube from which condensed moisture may be drained without having to manually remove the pan (223). FIG. 3 further depicts the attaching system (219) for the canister (501). The attaching system (219) is configured for sealedly interlocking with the canister (501) to allow wine to flow from the canister (501) into the device's (101) internal tubing when the pump (217) is activated, and ultimately to the spigot (103) and/or aerator (225).

As can be seen in FIG. 3, the cooling area (211) includes a cooling system (221) disposed at least partially therein. In the depicted embodiment, the cooling system (221) is disposed partially within the cooling area (211), and passed through the insulation (215) to be adjacent to the heat sink (207) disposed in the duct (201). Thus, warmer air in the cooling area (211) can be drawn out of the cooling area (211) using the cooling system (221), and dissipated into the duct by the heat sink (207), and then expelled from the duct (201) by the fan (205).

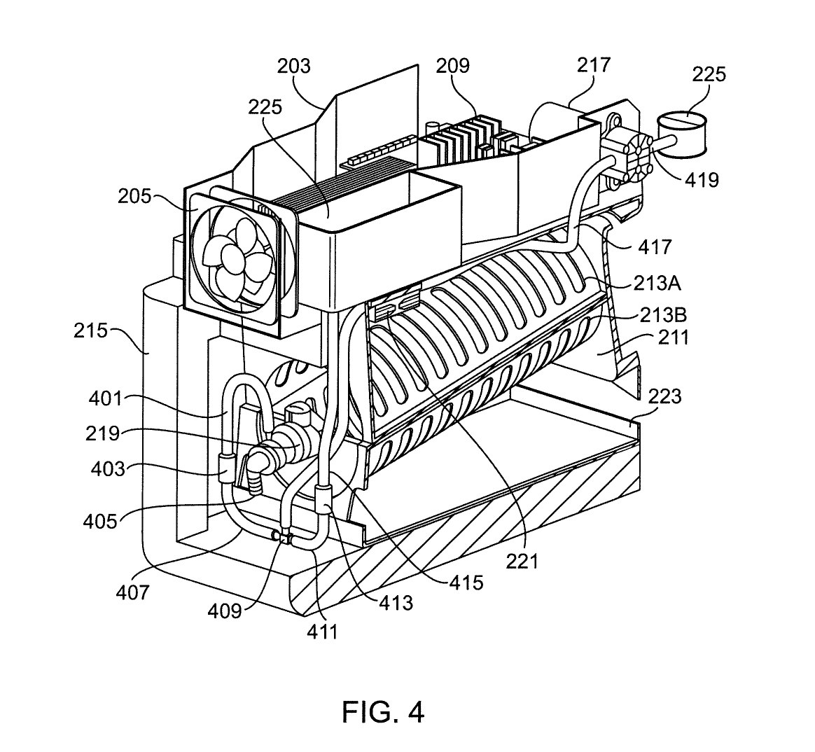

FIG. 4 depicts a cutaway isometric view of the interior of the device (101). In the depicted embodiment of FIG. 4, it can be further seen that the attaching system (219) for the canister (501) is in fluid communication with the aerator (225) and pump (217) via a series of tubes. In the depicted embodiment, a tube (401) connects the attaching system (219) to a check valve (403), which is in turn connected by a tube (407) to a T-valve (409). The T-valve (409) has two further connections. The first further connection is by a tube (417) to the pump (217) and aerator (225). The second is to another check valve (415), and from there via another tube to a purge reservoir (225). The purge reservoir (225) is generally for cleaning the unit, such as by disposing a cleaning fluid in the reservoir. The device (101) can then be operated to allow the cleaning fluid to flow through the internal tubing and clean the system. However, in normal operation, wine flows from a canister (501) to the T-valve (409) and then to the pump (217) and aerator (225).

It can also be clearly seen in FIG. 4 that the cradle (312) includes a number of openings. The depicted cradle (213) includes a plurality of regularly spaced openings. These further help to cool wine in the canister (501) by exposing more of the canister surface area to the cool ambient air in the cooling area (211). The depicted cradle (213) is disposed of two corresponding halves (213A) and (213B) which when joined form a tube sized and shaped to accommodate a canister (501). Again, the cradle (213) is generally disposed at an angle, with the dispensing end of the canister (501) at a lower elevation so that gravity can cause fluid flow from the canister (501).

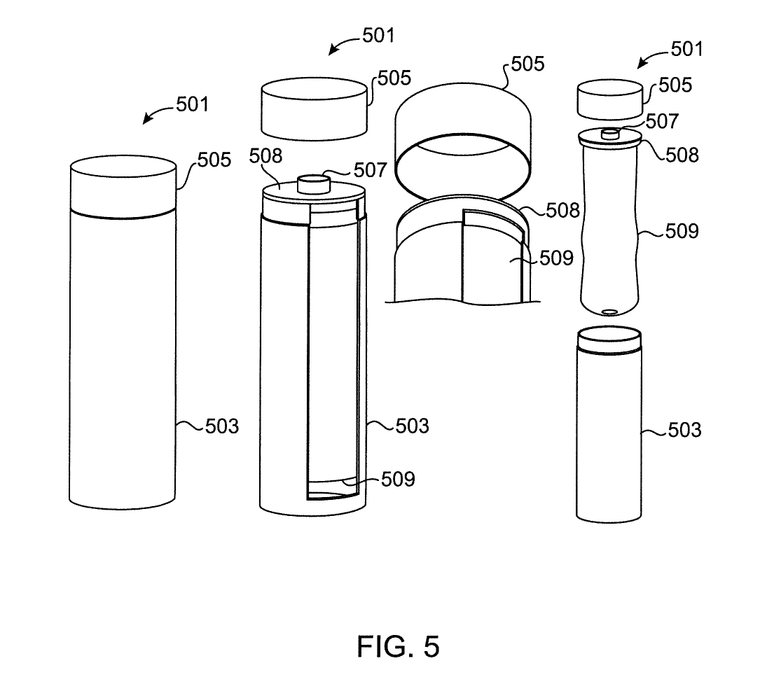

FIG. 5 depicts a canister (501) for use with the system. The depicted canister (501) is a generally cylindrical object including a body (503) and a removable lid (505). The interior of the body (503) is hollow, as can be seen in the cutaway of FIG. 5. The canister (501) further comprises a cap (508) with an attached bag (509). The body (503) is closed at a base end and open at an opposing top end, and cap (508) is configured for attaching to the open top end such that the bag (509) is then disposed in the hollow interior of the body (503). The cap (508) includes an opening (507) in fluid communication with the bag (509). This opening (507) can be used to both fill the bag (509) and drain wine out of the bag (509) during use of the device. The lid (505) protects the cap from possible damage and seals the canister (501) closed during transport. The canister (501) may be generally sized and shaped to hold an amount of wine equal to multiple conventional bottles. The depicted canister (501) may have the capacity of several bottles of wine. In an embodiment, the canister (501) is configured to hold about 2.2-2.25 liters of wine, or three standard bottles. In an embodiment, the canister (501) has a diameter of about four inches and a length of about twelve inches. These dimensions are selected to both facilitate the volume preference, fit in the cradle (213), and be comfortably held by the user in one hand. The canister (501) may be a canister (501) sold under the brand name Sylo™ and is sometimes also referred to in the art as a “silo.” The open end of the body (503) may be configured to interlock with the attaching system (219) such as via a nozzle (519).

In an embodiment, the canister is attached to the system using a fitment. The fitment is a connector that provides a fluid seal preventing atmospheric contamination of the contents of a container during transportation, but which can facilitate fluid communication between the container and exterior when attached to a properly configured corresponding attaching system. For example, for carbonated beverages such as soda, bag-in-box systems comprise a fluid bladder containing flavored syrup surrounded by an outer box shell. A fitment attached to the bladder can be connected to a fountain soda system and carbonated water tank to create on-demand carbonated soda in various flavors.

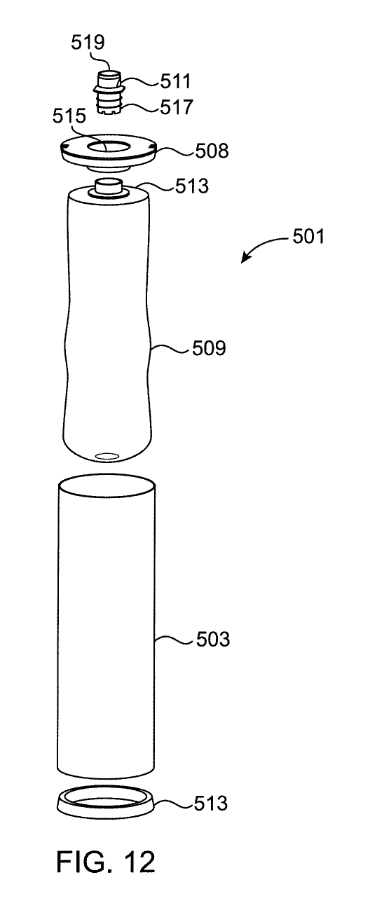

In the depicted embodiment, a marlow or conrow-style fitment may be used. Such a fitment maintains the fluid seal until placed in the cradle and rotated. The rotational element opens the seal and allows fluid flow from the canister into the fluid system of the wine dispenser, maintaining the vacuum of the fluid systems, which facilitates fluid flow out of the canister. The canister can then be counter-rotated to re-establish the fluid seal of the canister and disconnect it from the system. Such fitments are also known in the art, and are generally preferred because they facilitate preservation of the wine while being interchanged. As seen in FIGS. 5 and 12, for example, the fitment (513) may be attached to one end of the fluid bladder or bag (509), which is then placed inside a harder outer shall or tube (503) of the canister, with the fitment (513) disposed at one end. A cap (508) having a center opening (515) is then attached to hold the assembly together, with the fitment (513) protruding through the center opening (515).

The bag (509) is collapsible, and when filled should contain little to no air. The interior components of the system generally maintain a vacuum, so that when wine is drawn out of the bag (509) during use, the bag (509) collapses. As such, the portion of the interior body (503) between the bag (509) and the walls of the body (503) need not be airtight, as it is desirable that atmospheric pressure apply force to the outside of the bag (509), facilitating collapse as the wine is drained. This feature is desirable because oxygen is known to reduce wine quality. In an embodiment, atmospheric force is allowed into the interior of the canister (501) through one or more holes in the bottom cap.

To use the device, a canister (501) is filled with the desired type of wine (i.e., the bag (509) is filled), and the lid (505) of the cradle is removed and the canister (501) is inserted, cap (508) first, into the cradle (213). The cap (508) interlocks with corresponding components of the attaching system (219), forming an airtight seal that prevents or inhibits ambient air from interacting with the wine. When the system is operated, wine is drawn out by the pump (217) and flows to the spigot (105).

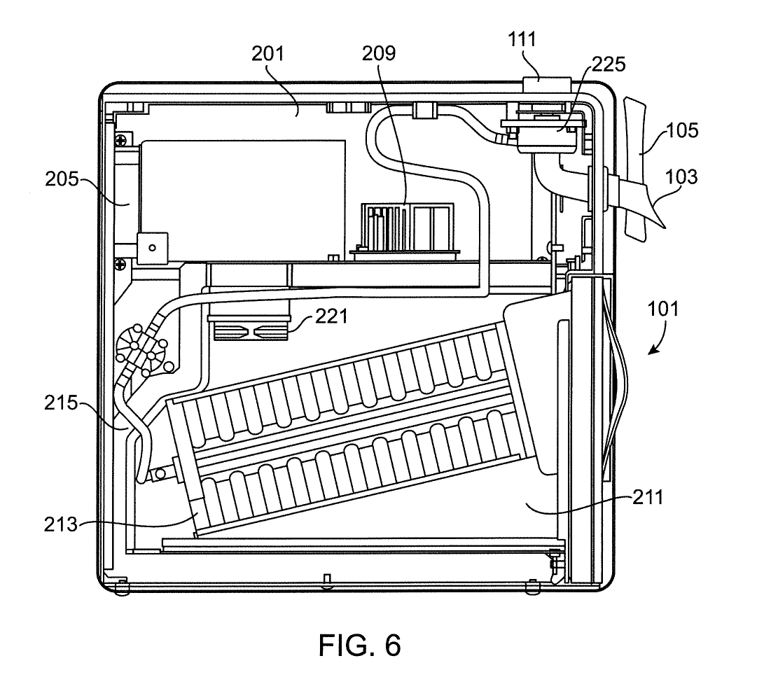

FIG. 6 depicts a side elevation cutaway view of the internal components of the device (101). As can be seen, when the canister (501) is situated in the cradle (213), the door (107) can be shut, isolating the interior of the cooling area (211) from the ambient atmosphere. The interlocking of the cap (508) with the attaching system (219) may be accomplished by turning or twisting the canister (501) in the cradle, causing components of the cap (508) to interface and interlock with corresponding components of the attaching system (219). In an embodiment, the canister is turned about one quarter of a complete turn to form the interlocking connection with the attaching system (219).

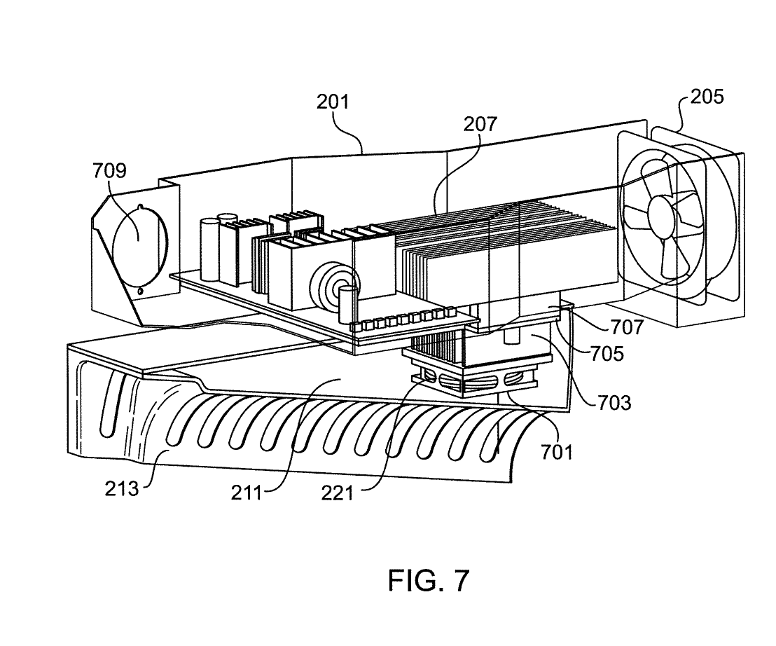

FIG. 7 depicts further details of the cooling system (221). The depicted cooling system (221) comprises a fan (701) disposed adjacent to a heat sink (703), which is in turn connected to a Peltier cooler (705), which is in turn connected to an spacer (707), which is in turn connected to the heat sink (207) through an opening in the walls of the cooling area (211). This assembly should fit snugly so that heat in the duct area (201) does not move to the cooling area, but rather the heat in the air in the cooling area (211) is cooled by drawing heat out using the cooling system (221). Although in the depicted embodiment, a Peltier cooler is depicted, in an alternative embodiment, a different cooling system may be used, such as, without limitation, any cooling system known in the art.

The fan (701) circulates air in the cooling area to provide more even temperature throughout, as the cooling system (211) will cause cooling near it. While warmer air should move to the top of the cooling area (211) to displace the cooler air, the cooling works more efficiently if the air is circulated, as pockets of warmer air with insulating properties will not remain. The heat sink (703) portion is also disposed in the cooling area (211), absorbing heat from the air in the cooling area (211).

This absorbed heat is then transferred to a spacer (707) using a Peltier cooler (705). A Peltier cooler uses the Peltier effect to create a heat flux between the junction of two different materials, effectively providing a solid-state heat pump. The depicted Peltier cooler (705) transfers heat from the heat sink to the spacer (707). The spacer (705) is tightly disposed in the opening in the cooling chamber (211). This opening would place the cooling chamber (211) in fluid communication with the duct (201) but for the spacer (707). It is preferred that little or no amount of the spacer (707) is in fluid communication with the interior of the cooling chamber (211), so that heat transferred to the spacer (707) does not heat the interior of the cooling area (211), thereby reducing efficiency. It is also preferred that the Peltier cooler be disposed in a similar fashion. That is, it is preferred that the only components of the cooling system (221) in direct fluid communication with the air in the cooling chamber are the fan (701) and heat sink (703). The other components are generally disposed in the opening surrounded by insulation. The depicted spacer is made from aluminum but any thermally conductive material can be substituted.

Thus, the cooling system cools the air in the cooling chamber (211) by circulating the air using the fan (701), and absorbing heat using the heat sink (703). This heat is then transferred to the spacer (707) using the Peltier cooler (705). The spacer is in thermally conductive contact with the heat sink (207) in the duct (201), which transfers the heat to the air blowing across it (207), which is drawn by the fan (205) blowing air out of the duct (201), and the duct (201) itself is shaped to route cool air over the electronic components (209) and heat sink (207).

The following description generally pertains to the operation of a device according to the present disclosure. The wine dispensing system of the present disclosure is generally operated by first inserting a canister (501) containing the desired type of wine in a bag (509) into the cradle (213). The canister (501) may be equipped with a temporary cap to prevent spillage during transportation. This temporary cap is removed, and the canister (501) is inserted into the cradle (213) nozzle-first, until the nozzle (519) interacts with the attaching system (213). The user then twists the canister (501) axially to lock the canister (501) into place in the cradle (213). This establishes an airtight/fluid-tight seal with the attaching system (219). When the user turns the handle (105), the pump (217) operates, drawing wine out of the canister (501) to the aerator (225). The wine flows through the tube (417) connecting the pump (217) to the aerator (225). This tubing may be any food-grade tubing known in the art. It is preferred that such tubing (217) be routed through the cooling chamber (211) as much as possible or practical in order to refrigerate the wine that remains in the line (417).

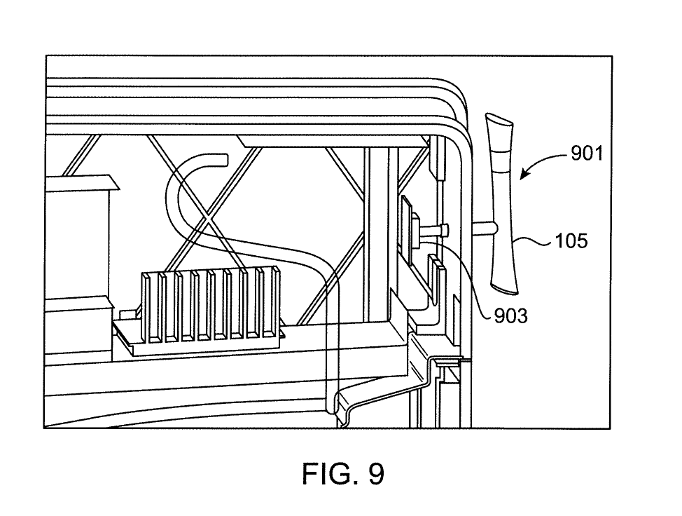

As depicted in FIG. 9, the pump (217) is connected to the handle (105) via a potentiometer (903). Rotating the handle (105) alters the voltage going through the pump (217) via the potentiometer (903), which in turn throttles the flow rate of wine from the canister (501) to the aerator (225). In this manner, the flow of wine from the device (101) is controlled by the degree of rotation of the handle (105). FIG. 9 depicts an embodiment using a variable flow rate pour control handle (901) and a potentiometer (903). Potentiometers (903) of this type are known in the art and any appliance-grade potentiometer (903) with the appropriate voltage may be used.

In an embodiment, the pump (217) is a food-grade pump configured to pump edible liquids. The pump (217) will preferably have a flow rate of about 1.2 liters per minute, and is preferably self-priming and quiet. It is also preferred that the pump (217) is capable of running dry for a period of time without damage. It will be understood that a pump (217), such as this, will not be harmed if the canister (501) is empty, and fluid can no longer be pumped out. In an embodiment, a Topsflo model TG-02BZ-12-015 pump (217) is used. Such a pump (217) has appropriate characteristics, such as being self-priming, having a flow rate of about 1.5 liters per minute, and a long life of approximately 800 operating hours. Although this type of pump has a flow rate of 1.5 liters per minute, which is slightly higher than the preferred flow rate of 1.2 liters per minute, the voltage supplied to the pump (217) may be reduced, if desired, using electrical components, known in the art, to reduce the effective flow rate of the pump (217) to about 1.2 liters per minutes.

In an embodiment, the system further comprises an automatic shutoff system which causes the pump (217) to cease operating under certain circumstances. By way of example and not limitation, the automatic shutoff system may include a moisture sensor or other means for determining whether the canister (501) is empty or nearly empty. In such an instance, the automatic shutoff system will shut off the pump (217) to minimize the risk of damage. Similarly, in another embodiment, the automatic shutoff system may comprise a timing mechanism or other means for determining the amount of time that the pump (217) has been in continuous operation, and shuts the pump (217) off if it has been running for an unusually high period of time. For example, the pump (217) could possibly become damaged if it ran with fluid for more than five minutes continuously, or if it ran for more than one minute while dry. In a further embodiment, the automatic shutoff system may comprise both components. That is, the system may determine the amount of time that the pump (217) has been operating, and, if the canister (501) is empty, shut the pump (217) off after one minute, otherwise, after five minutes. This system may be further connected to a display to provide a warning to the user that the system should be shut off for a period of time to prevent damage to the pump (217). This reduces user confusion when the device will not pump. Similarly, the display may be connected to a sensor showing whether the canister (501) is empty, so the user can be made aware that the canister (501) needs to be refilled.

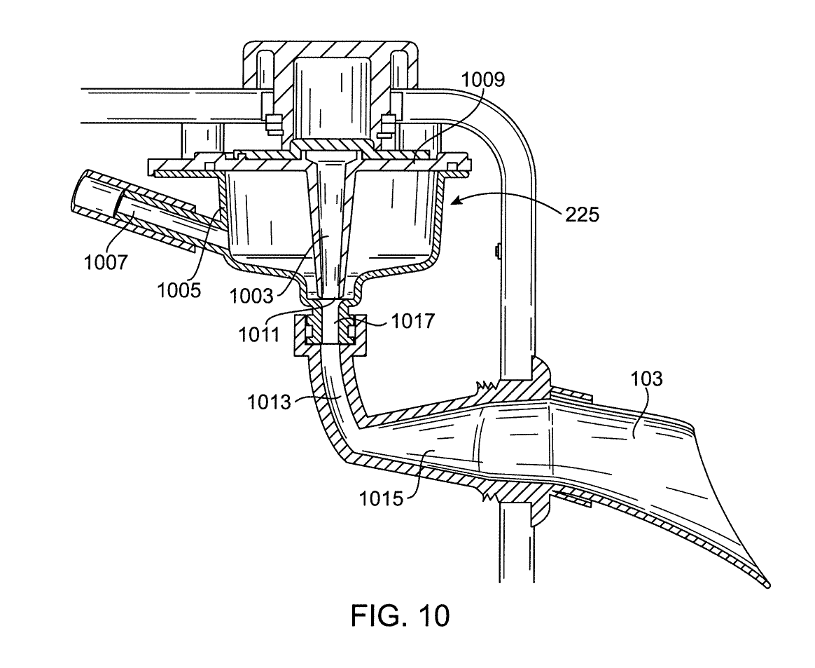

In the depicted embodiment of FIG. 10, an aerator (225) is shown. The depicted aerator (225) is generally similar to Venturi-based aerators, but differs from the prior art in that it (225) introduces air into the stream of wine just above where the Venturi begins to narrow. In the prior art, Venturi aerators introduce air in a narrow portion of the Venturi through holes in the side. However, in applicant's device (101), this can cause wine to leak into the appliance. By disposing the air tube (1003) above the narrow portion, the wine is inhibited from leaking into the appliance, and also gives the wine stream a more full-bodied and bubbly texture. This also generally results in a noticeable improvement to the taste of wines, and particularly, red wines.

In a traditional Venturi aerator, air is introduced to the wine stream through holes in the side of the device. However, in the depicted aerator (225), air is introduced via a tube (1003), which introduces the air at a point prior to the portion of the aerator reservoir (1005) before the reservoir begins to narrow. In the depicted aerator (225), a wine inlet (1007) allows wine to flow into the reservoir (1005), or basin (1005), of the aerator (225). The depicted inlet (1007) is angled downward toward the basin (1005) to reduce wine residue from building up in the internal tubing of the system. Such buildup can result in dripping after a pour. Wine in the basin (1005) is prevented from spilling out over the top of the basin (1005) by an aerator cap (1009). In the depicted embodiment, the cap (1009) is structurally attached to the aerator tube (1003). In the depicted aerator (225), air is inserted into the wine stream as it passes the aerator tip (1011), before the wine flows into an egress tube (1013) and from there into the spigot (103). In the depicted embodiment, a funnel (1015) is disposed between the egress tube (1013) and the spigot (103).

The depicted egress tube (1013) is at an angle generally downward, with a slight bend towards the spigot (103) at the bottom end of the egress tube (1013). This shape, like that of the inlet (1007), is important to preventing post-pour dripping by inhibiting wine from remaining in the system, and encouraging wine to fully evacuate the system.

The aerator (225) will necessarily slow the rate of wine flow, which results in wine backing up into the basin (1005). Thus, the basin (1005) is sized and shaped to have a sufficient volume to accommodate wine backup, based on the egress flow rate of wine out of the aerator (225) and into the egress tube (1013). As can be seen in FIG. 10, the tip (1011) of the air tube (1003) is disposed above the egress funnel (1017) of the aerator. This design differs from prior art Venturi aerators.

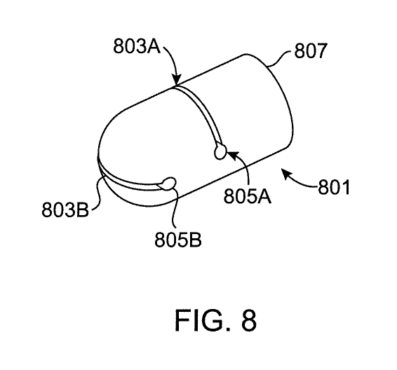

In an embodiment, the device (101) may comprise a means or mechanism for displaying a label. The means or mechanism may be integrated into the device (101), or be an attachable component. An embodiment of such a mechanism is depicted in FIG. 8. In the depicted embodiment of FIG. 8, a label holder (801) is a generally cylindrical component (801) having at least one generally linear channel, trough, or slot partially therethrough (803A). The channel (803A) is configured to releaseably, but snuggly, hold a business card-sized label in place. The card is held in place through friction with the interior surfaces of the channel (803A). This connection should be snug enough to prevent the card from becoming dislodged if the device (101) is bumped, or even with a mild breeze, such as that caused by fans, forced-air ducts, or persons passing by.

As can be seen in the depicted embodiment of FIG. 8, the channel (803A) comprises a generally circular hollow portion (805A) disposed at the base of the channel (803A). The generally circular hollow portion (805A) has a diameter wider than the width of the channel (803A). This allows the label holder (801) to bend or flex transversely to the channel (803A) to further facilitate the snugness of the friction-based fit described herein. In the depicted embodiment of FIG. 8, the label holder (801) has a magnetic end (807) which can be used to select where on the device (101) to place the label holder (801).

In the depicted embodiment of FIG. 8, the label holder (801) further comprises a second channel (803B) disposed at an end of the holder (801) opposing the magnetic end (807). This channel (803B) is oriented generally perpendicularly to the first channel (803A), allowing the holder to be used in both horizontal and vertical configurations. The second channel (803B) may also contain a round cylindrical portion (805B), similar to the cylindrical portion (805A) for the first channel (803A), serving the same purpose. In a further embodiment, the first channel (803A) may be disposed at the end opposing the magnetic end, and there may be no second channel.

In the depicted embodiment of FIG. 12, an exploded view of a canister (501) is depicted. The depicted canister (501) comprises a body (503), a bag (509), a top cap (508) a valve (511) and a bottom cap (513). The depicted body (503) is a generally cylindrical paperboard tube open at the top and bottom ends. The bag (509) is a flexible, watertight bag as described elsewhere herein and is attachable to the top cap (508) via an open tip (513). The top cap (508) is a generally cylindrical disc shaped component with an aperture in the middle for accepting the open tip (513) of the bag (509).

The bag (509) is attached to the top cap (508) by placing the tip (513) through the opening (515) in the top cap (508) and attaching the tip (513) to a corresponding portion (517) of the valve (511) through the opening (515). The valve (511) comprises, on one end, a connecting portion (517) for connecting to the tip (513) of the bag and an opposing nozzle (519) for connecting to the attaching system (219).

The bottom cap (513) is a generally disc-shaped element attachable to the open bottom end of the body (503). The bottom (513) generally has one or more air holes for allowing air to enter the tube (513), allowing atmospheric pressure to collapse the bag (509) disposed in the tube (503).

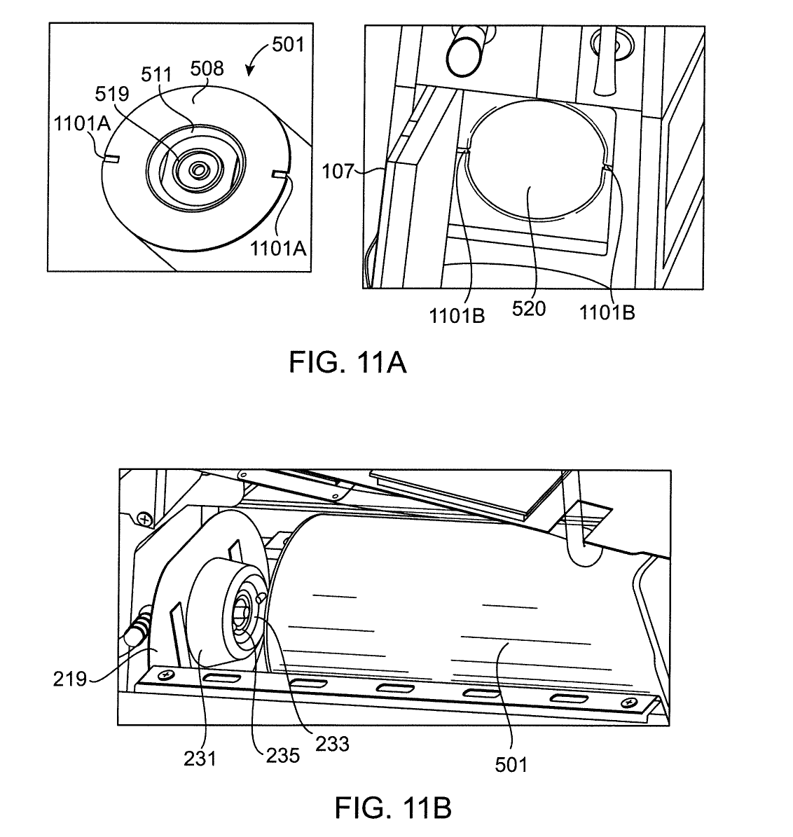

FIGS. 11A and 11B depict a more detailed diagram of the connection of the canister (501) to the attaching system (219). In the depicted embodiment of FIGS. 11A and 11B, the canister (501) is depicted from a top down view showing the top cap (508) with the valve (511) disposed therein with the nozzle (519) facing upward. The top cap (508) has alignment guides (1101A) disposed thereon. The depicted top cap (501) has a top side and an opposing bottom side, with the bottom side facing the body (503). It is on depicted top side, which has the alignment guides (1101A) thereon. The depicted alignment guides (1101A) are disposed near the outer periphery of the circular shape of the top surface of the top cap (508). The depicted alignment guides (1101A) are disposed generally on opposing sides of the top cap.

Also, as particularly shown in FIG. 11A, there are corresponding alignment guides (1101B) disposed on the exterior of the apparatus (101). These alignment guides (1101B) assist the user, when inserting the canister (501) into the device (101), as to how to orient the canister (501) for easy installation. The user aligns the alignment guides (1101A) on the canister with the corresponding alignment guides (1101B) on the exterior of the device (101), and then presses the cylinder through the opening (520) in the device (101), which provides access to the cradle (213) disposed inside the device (101). The depicted alignment guides (1101B) on the exterior of the device (101) are disposed behind the door (107), and correspond to the location of the alignment guides (1101A) on the cylinder (501).

FIG. 11B depicts the interior of the device (101) during installation of the canister (501). The depicted attaching system (219) comprises a guidance fixture (231) configured to interlock with the canister (501). The depicted guidance fixture (231) comprises a truncated, generally conical body, having a flat top portion with an opening (233) at the end. The opening (233) is sized and shaped to accommodate the nozzle (519) of the valve (511). Disposed within the opening (233) is a corresponding female valve (235) with which the nozzle (519) of the canister (501) interlocks. Such interlocking valves are well known in the art.

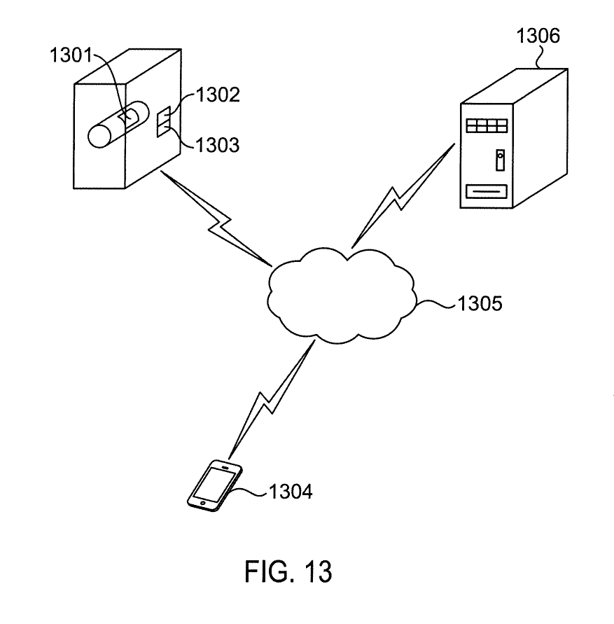

In the depicted embodiment of FIG. 13, the canister includes an identifier (1301) corresponding to the wine content of the canister. This identifier (1301) may be an optically recognizable identifier (1301), such as a QR code or bar code, or may be non-visible, such as an RFID tag (1301). The dispenser is then equipped or configured with a scanner (1302) or scanning means (1302) configured to read or detect the identifier (1301). This detected identifier (1302) is then used to, for example, display a human-readable indication of the wine, such as on a display for the dispenser. This display may be built in to the dispenser, such as an LCD screen, or may be a display of a separate computer system such as a mobile device (1304). In the latter case, the dispenser may further include a transmitter (1303) and appropriate control logic for communicating the wine identification to the computer and/or mobile device.

Additionally, or alternatively, the identifier (1301) may be transmitted over a network (1305) to a remote server system (1306) or cloud service (1306), where it may be stored in association with a registration for the owner or user of the dispenser. The remote server system (1306) may be further programmed to track the wines used with the particular dispenser and/or user, and may further receive user profile and/or user preference data from users via computer software running on a client device (1304). Alternatively, the computer software may be running on an internal computer systems integrated into the dispenser. For cost-effectiveness, in the preferred embodiment, the client software runs on a mobile device (1304). The application may facilitate the user providing preference data to the server system (1306), such as by answering questions or providing ratings pertaining to the user's opinion of the particular wine in the canister as determined via the identifier (1301).

For example, the user may be able to provide qualitative and/or quantitative ratings for the wine via the application. Additionally, and/or alternatively, the user may be able to provide a likability rating, or identify the flavors that the user tastes in the wine. This data may be stored and processed by the server (1306) to make recommendations to the user for other wines the user may also like. This may be done, for example, by considering which wines the user liked and disliked, and what flavors the user detected in each.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A wine dispensing system comprising:
a fluid silo comprising an internal bladder inside an outer housing, said internal bladder having a fluid connector fitment at an end thereof;
a housing having a chilled chamber and an unchilled chamber;
a cradle disposed in said chilled chamber, said cradle configured to hold said fluid silo;
a fluid connecting system disposed in said chilled chamber and configured to connect fitment of said fluid silo when disposed in said cradle;
a dispensing nozzle external to said housing and in fluid communication with said fluid connecting system; and
a cooling system configured to cool said chilled chamber.

2. The wine dispensing system of claim 1, further comprising:
said fluid silo comprising an identifier of the fluid content of said fluid silo;
a scanning means configured to detect said identifier when said fluid silo is in said cradle; and
a transmitter configured to transmit said detected identifier.

3. The wine dispensing system of claim 2, wherein said identifier comprises a radio frequency identification (RFID) tag.

4. The wine dispensing system of claim 3, wherein said scanning means comprises an RFID tag reader.

5. The wine dispensing system of claim 2, wherein said transmitter is a short-range radio frequency transmitter.

6. The wine dispensing system of claim 2 further comprising a display configured to receive signals indicative of said identifier and to display a visual representation of said identifier.

7. The wine dispensing system of claim 6, wherein said visual representation is selected from the group consisting of: a word; a phrase; a logo; a brand name; bottle label; and, a type of wine.

8. The wine dispensing system of claim 2, further comprising:
a computer configured to receive said transmitted detected identifier.

9. The wine dispensing system of claim 8, wherein said computer comprises a mobile device.

10. The wine dispensing system of claim 9, wherein said mobile device comprises a smart phone, tablet computer, or wearable computer.

11. The wine dispensing system of claim 8, wherein said computer comprises a non-transitory computer-readable medium having program instructions thereon for causing said computer to receive said detected identifier transmitted by said transmitter.

12. The wine dispensing system of claim 11, wherein said non-transitory computer-readable medium further comprises program instructions for:
receiving user input indicative of user ratings of a wine;
selecting other wines the user may like based upon said received user ratings;
transmitting identifiers for said selected other wines.

13. The wine dispensing system of claim 2, further comprising a remote computer server comprising a non-transitory computer-readable medium having program instructions thereon for causing said remove server to receive said detected identifier transmitted by said transmitter.

14. The wine dispensing system of claim 1, wherein said fitment connects to said fluid connecting system by rotating said fitment.

15. The wine dispensing system of claim 1, further comprising a pump operatively connected to a manipulable control which, when manipulated, causes said pump to operate to draw fluid from said fluid silo connected to said fluid connecting system.

16. The wine dispensing system of claim 15, wherein said fluid drawn from said fluid silo flows to and is dispensed from said dispensing nozzle via a fluid conduit.

17. The wine dispensing system of claim 16, further comprising a wine aerator disposed between said fluid connecting system and said dispensing nozzle in said fluid conduit.

18. The wine dispensing system of claim 1 further comprising a heat sink disposed between said chilled chamber and said unchilled chamber, said heat sink configured to remove heat from said chilled chamber and radiate said removed heat into said unchilled chamber.

19. The wine dispensing system of claim 1, wherein said unchilled chamber further comprises one or more vents, and one or more fans in said unchilled chamber.
